(19) United States
(12) Patent Application Publication
(10) Pub. No.: US 2011/0061079 A1
(43) Pub. Date: Mar. 10, 2011

(54) Broadcast Receiver and Broadcast Receiving Method

(76) Inventor: Tomotaka Ida, Kumagaya-shi (JP)

(21) Appl. No.: 12/826,284

(22) Filed: Jun. 29, 2010

(30) Foreign Application Priority Data
Sep. 9, 2009 (JP) 2009-207804

(51) Int. Cl. H04N 5/445

(52) U.S. Cl. 725/53

(57) ABSTRACT

A broadcast receiver including: a storage configured to store pieces of program information of digital broadcast programs; a user interface configured to receive input of characters relating to digital broadcast programs when a search relating to digital broadcast programs is to be performed using broadcast waves or the Internet; a selecting module configured to select a keyword that is stored in the storage and considered to match the input characters; and a search module configured to perform a program-related search using the selected keyword.

### CROSS-REFERENCE TO THE RELATED APPLICATION(S)

The present application is based upon and claims priority from prior Japanese Patent Application No. 2009-207804, filed on Sep. 9, 2009, the entire contents of which are incorporated herein by reference.

### BACKGROUND

1. Field

The present invention relates to a broadcast receiver and a broadcast receiving method having a keyword based program search function.

2. Description of the Related Art

Information processing apparatus that operate while exchanging information with the Internet have been used conventionally. For example, in the information search apparatus disclosed in JP-A-2004-362121, a word having a high frequency of appearance among words included in pieces of text information obtained from the Internet by a search performed using an input keyword or a word that is highly related to the keyword among those words is employed as a new keyword and a program information database is searched using the new keyword. On the other hand, data broadcast is known which relates to such information processing apparatus. For example, a quiz program is broadcast as a TV or radio program and quizzes are set in a data broadcast in link with the quiz program. However, being such that an answer to each quiz is selected from preset answers that are given respective numbers, this system does not have a high degree of freedom. That is, the user cannot use a new keyword.

As described above, although there exist information processing apparatus that have an Internet browser function and can make an Internet free word search (broadcast receiver such as TV receivers in the broadcast field, for example), they are low in convenience because they are not provided with a search function having a high degree of freedom in a sense that a search is linked with a broadcast.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a block diagram outlining a configuration of a TV receiver according to an embodiment of the present invention.

FIG. 2 shows an example remote controller having an electrostatic pad for input of hand-written characters which is used in the embodiment.

FIG. 3 shows an example picture for an Internet search and a conversion from input hand-written characters into a keyword in the embodiment.

FIG. 4 shows example sets of points of conversion result candidates of a conversion from input hand-written characters into a keyword in the embodiment.

### DETAILED DESCRIPTION

An embodiment according to the present invention will be described in detail with reference to the accompanying drawings. The scope of the claimed invention should not be limited to the examples illustrated in the drawings and those described below.

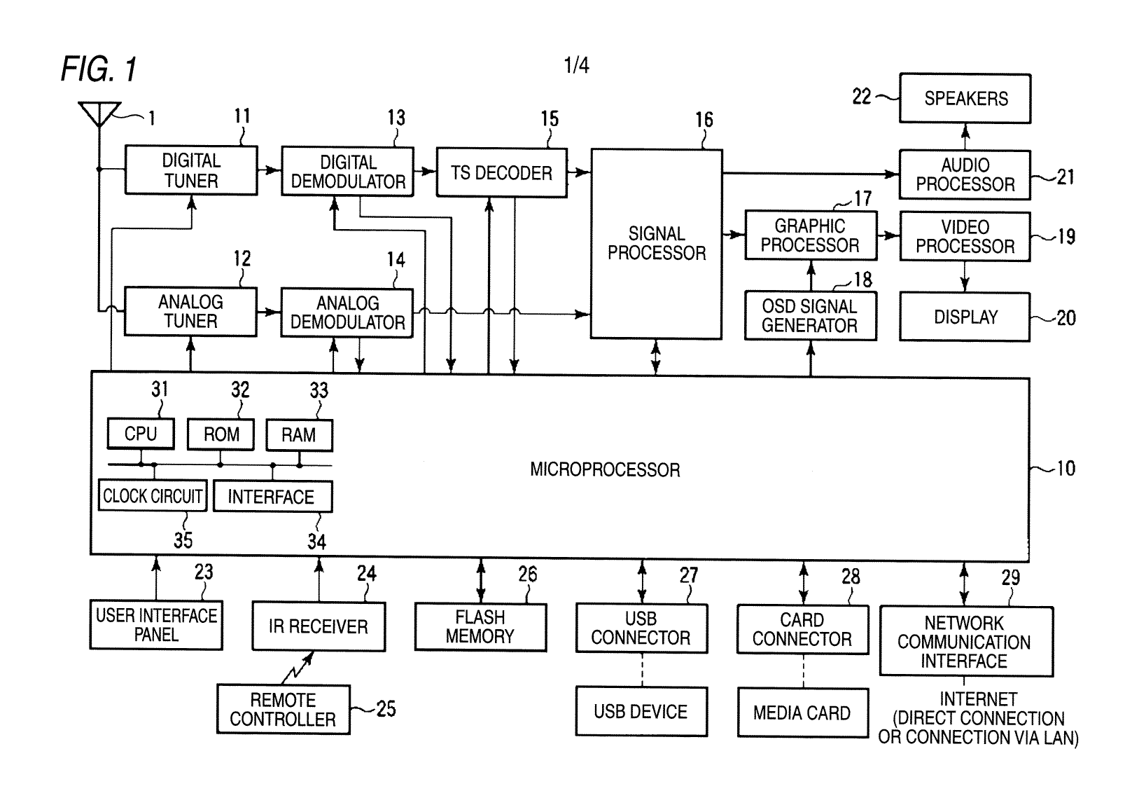

A TV receiver according to an embodiment of the present invention will be hereinafter described with reference to FIGS. 1-4.

FIG. 1 outlines the configuration of the TV receiver according to the embodiment of the invention. The TV receiver, which can receive terrestrial analog broadcast waves and BS, CS, and terrestrial digital broadcast waves, is equipped with a microprocessor 10, a digital tuner 11, an analog tuner 12, a digital demodulator 13, an analog demodulator 14, and a TS decoder 15.

BS, CS, and terrestrial digital broadcast waves are received by an antenna 1 and resulting reception signals are supplied to the digital tuner 11. Likewise, terrestrial analog broadcast waves are received by the antenna 1 and resulting reception signals are supplied to the analog tuner 12. Each of the digital tuner 11 and the analog tuner 12 employs a phase-locked loop (PLL), and is used for tuning in to a desired broadcast signal by specifying reception parameters such as a center frequency and a bandwidth under the control of the microprocessor 10.

For example, in the case of the terrestrial digital broadcast in Japan, the broadcast reception signal selected by the digital tuner 11 is supplied to the digital demodulator 13 which is of an OFDM (orthogonal frequency division multiplexing) type and then to the TS decoder 15, whereby it is demodulated and decoded into a digital video signal and audio signal. The reception signal selected by the analog tuner 12 is supplied to the analog demodulator 14, where it is demodulated into an analog video signal and audio signal.

The TV receiver is also equipped with a signal processor 16, a graphic processor 17, an OSD (on-screen display) signal generator 18, a video processor 19, a display 20, an audio processor 21, speakers 22, an user interface panel 23, an IR receiver 24, a remote controller 25, a flash memory 26, a USB (universal serial bus) connector 27, a card connector 28, and a network communication interface 29. The signal processor 16 selectively performs various pieces of digital signal processing on the digital video signal and audio signal supplied form the TS decoder 15 and outputs resulting video signal and audio signal to the graphic processor 17 and the audio processor 21, respectively. Furthermore, the signal processor 16 selectively digitizes the analog video signal and audio signal supplied from the analog demodulator 14, performs prescribed pieces of digital signal processing on resulting digital video signal and audio signal, and outputs resulting video signal and audio signal to the graphic processor 17 and the audio processor 21, respectively.

The graphic processor 17 selectively superimposes an OSD signal generated by the OSD signal generator 18 on the digital video signal that is output from the signal processor 16, and outputs a resulting video signal. The video processor 19 performs, on the digital video signal that is output from the graphic processor 17, conversions such as a size adjustment to make the digital video signal suitable for the display 20. The display 20 displays video corresponding to the video signal that is output from the video processor 19. The audio processor 21 performs, on the digital audio signal that is output from the signal processor 16, conversions such as a volume adjustment to make the digital audio signal suitable for the speakers 22. The speakers 22 reproduce audio corresponding to the audio signals that are output from the audio processor 21.

The microprocessor 10 receives operation command supplied from the user interface panel 23 or operation command transmitted from the remote controller 25 and received by the IR receiver 24, and controls individual components in such a manner that the content of the manipulation is reflected therein. The user interface panel (keyboard) 23 and the remote controller 25 correspond to a manipulation module that functions as a user interface. As shown in FIG. 1, the microprocessor 10 includes a CPU 31 which performs various kinds of processing and control, a ROM 32 which holds control programs of the CPU 31 and various initial data, a RAM 33 which provides a work area where input/output information of the CPU 31 is stored temporarily, an interface 34 for input/output of setting information and control information for each component via an I2C bus or the like, and a clock circuit 35 which is corrected according to time information and date information that are acquired from broadcast waves or over a network.

The USB connector 27 is provided for connection of various USB devices. The card connector 28 is provided for connection of various media cards. The network communication interface 29 is connected to the Internet directly or via a LAN (local area network). Where time information is to be acquired from broadcast waves, the microprocessor 10 captures it from a signal received by the antenna 1. Where basic data such as time information, weather information, and fortune-telling information are to be acquired over a network, the microprocessor 10 captures those data from the network communication interface 29.

BGM (preinstalled BGM) and various kinds of registration information to be used for reproduction of the BGM may be stored in the flash memory 26 (nonvolatile memory) in advance, that is, at the shipment stage of the TV receiver, by the manufacturer side.

Moving image, photograph, or musical data can be read via the USB connector 27 or the card connector 28 from an external USB device (memory or the like) or memory card that is connected to it.

To realize a photo viewer function, a photo frame function, for example, the microprocessor 10 is configured so as to be able to perform a control for capturing one or plural photo images that are held as files in a USB memory connected to the USB connector 27 or a media card connected to the card connector 28 and displaying each photo image on the display 20 after causing the signal processor 16, the graphic processor 17, and the video processor 19 to process it. A photo frame function is realized by operation of the TV receiver which is performed in a photoframe mode. In the photoframe mode, the user selects a favorite photo image from one or plural photo images held by a USB memory or a photo image media card by manipulating, for example, the remote controller 25 or the user interface panel 23 and the microprocessor 10 registers the selected favorite photo image in the flash memory 26. After the registration, the microprocessor 10 controls the OSD signal generator 18 etc. to display the favorite photo image on the display 20 as a photo frame image and, furthermore, to display an additional information image in such a manner that it is superimposed on the photo frame image. The microprocessor 10, the signal processor 16, the graphic processor 17, the OSD signal generator 18, and the video processor 19 constitute a display control module which, in the photo frame mode, acquires basic data of additional information for a photo frame image, composes an additional information image that represents the additional information corresponding to the basic data, and performs display control processing of superimposing the additional information image on a displayed photo frame image according to its own additional information settings.

Referring to FIG. 1, a signal on a viewing channel specified by the user is selected from received digital broadcast waves by the digital tuner 11. And data that is transmitted as part of the broadcast waves as program information (SI: service information) in addition to video and audio is acquired and stored in an HDD (not shown) or the flash memory 26 as data of an SI database (described later). The SI database is what is called a program information storage.

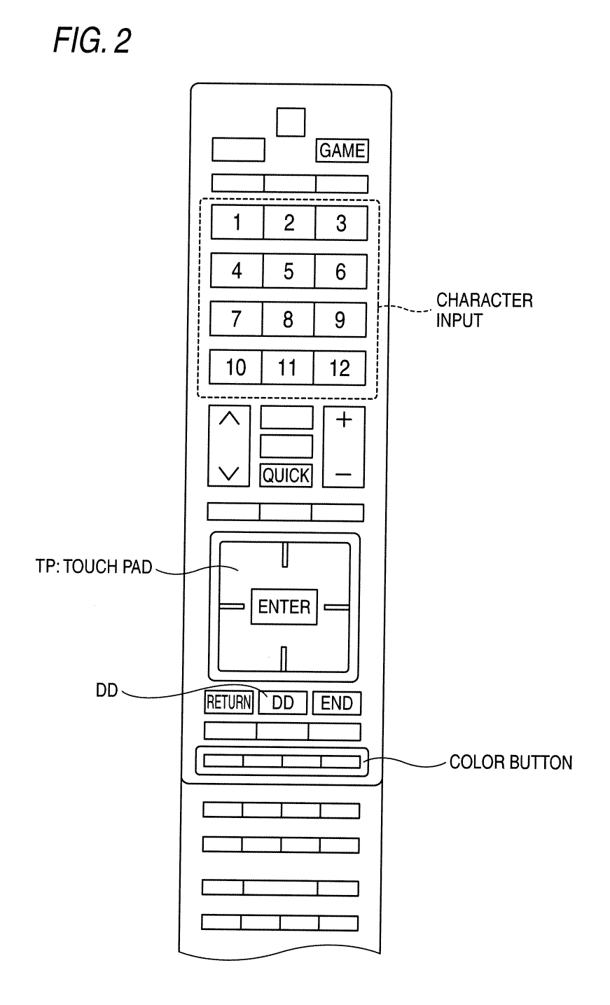

FIG. 2 shows an example of the remote controller 25 for remotely controlling the above system (TV receiver). The remote controller 25 is provided with an electrostatic pad for input of hand-written characters. The electrostatic pad is a touch pad TP which is indicated by a broken-line rectangle in FIG. 2. The remote controller 25 may be one that does not use infrared light. In the embodiment, the remote controller 25 is, for example, a remote control transmitter which is what is called an RF remote controller.

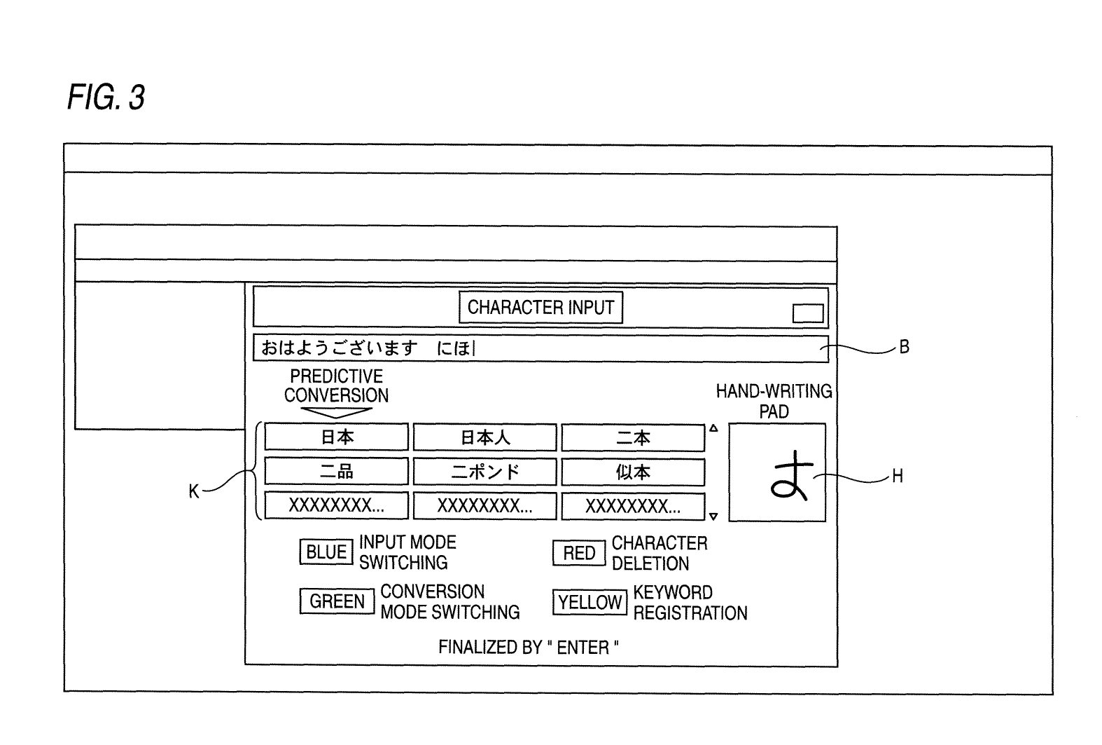

The functions of the touch pad TP will be supplemented later with reference to FIG. 3. Functions, deeply related to the embodiment, of the touch pad TP and buttons will be described below.

A d data button DD is provided for convenience of a broadcast-wave search and an Internet search, for example. For example, when the d data button DD is pressed, a connection is made to a particular search site and a keyword search window is popped up.

A return button is a button that is used for returning to a preceding menu picture halfway in a process of making any of various settings that are not limited to ones relating to the d data button DD.

In general, an end button is a button for finishes a setting procedure or the like and erasing a menu.

A quick button is a button for displaying, at each stage, a quick menu that is suitable for the stage.

Character input buttons are buttons that are usually used for selecting a channel directly and are also used in making a setting by inputting characters, numerals, and/or symbols.

In general, the touch pad TP is used for selecting an item in a setting menu by moving a finger on the pad and decides on the selected item by pressing a central enter button.

Color buttons (color keys) are used for making hard-disk-related settings etc. and is also used frequently with a setting menu picture as shown in FIG. 3.

FIG. 3 shows an example picture for an Internet search and a conversion from input hand-written characters into a keyword in the embodiment.

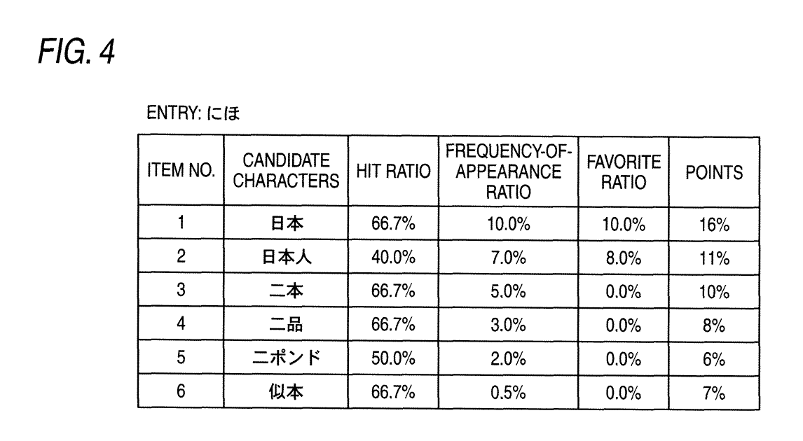

FIG. 3 shows an attempt to input characters to use a net search function of the Internet function of the above-described system. Pieces of coordinate information that are input through the electrostatic pad (touch pad TP) of the remote controller 25 are displayed as a brush trace H. Applications of the character input using an electrostatic pad are disclosed in JP-A-2008-046872 and JP-A-2009-055312, for example. Determined hiragana characters are input as reading kana characters, and each of keywords in the SI database is given points according to its reading kana characters hit ratio, frequency of appearance in the SI database, and frequency of use in pieces of program information of programs that the user have viewed or made reservations for recording in a manner shown in an example of FIG. 4 (described later). The keywords are presented as conversion result candidates Kin descending order of the points. The user can select and use one of those keywords. The example picture of FIG. 3 serves for such a function.

To reach the example picture of FIG. 3, for example, the user first presses the d data button DD to call a particular search site and then inputs “o-ha-yo-u-go-za-i-ma-su” in hiragana characters using the character input buttons. Then, the user presses the quick button of the remote controller 25 to display a quick menu and selects hand-writing input from the items in the menu. As a result, a text box B appears as a top picture in superimposition (see FIG. 3).

In FIG. 3, “ni-ho” in hiragana characters has been input by hand writing after the “o-ha-yo-u-go-za-i-ma-su” and the last and second last strokes of “ho” of “hi-ho” in hiragana characters remains as a display on a hand-writing pad. At this time point, conversion result candidates are presented in descending order of the points. For example, it is shown using a cursor (thick enclosing frame) that the characters shown in the first row in FIG. 4 has highest points. If the characters shown in the first row in FIG. 4 is not an appropriate conversion result candidate, the user can select another conversion result candidate by moving the cursor and decide on it.

After the state of FIG. 3, the input mode can be switched by pressing the blue color key. For example, input by the character input buttons is made effective again. Alternatively, an input mode in which a software keyboard is shown on the TV screen may be provided.

The conversion mode is switched by pressing the green color key. For example, a katakana character input mode is established, in which case the top-right mark in the window is changed from an icon showing kanji and hiragana characters to an icon showing katakana characters.

If the end button of the remote controller 25 is pressed, the hand-writing input is finished and the text box B is erased. On the other hand, if it is attempted to input other characters such as “rettou (archipelago)” in kanji characters, for example, after the character “nihon (Japan),” a conversion result candidate for the kanji characters for “rettou (archipelago)” is displayed when only the hiragana character “re-tsu” has been input by hand writing as in the case of the input of “ni-hon.” The user can select the conversion result candidate for the kanji characters of “rettou (archipelago).”

Incidentally, SI contains an FIT (event information table) which is program-related information such as a program name, a broadcast date and time, and details of a program. In general, an EPG (electronic program guide), which is used by the user of a TV receiver, is formed mainly based on EITs. In particular, since such character strings as the above-mentioned ones “nihon (Japan)” and “rettou (archipelgo)” can be extracted from program names and details of programs, extracted character strings are registered in the SI database as keywords and their numbers of times of appearance are counted.

FIG. 4 shows example sets of points of conversion result candidates of a conversion from input hand-written characters into a keyword in the embodiment.

In FIG. 4, six conversion result candidates having highest sets of points among the candidates shown in FIG. 3 are presented. For example, the hit ratio of the first candidate characters for kanji characters for “nihon (Japan)” is calculated as 66.7%. This is a percentage representation of 2/3 (the two hiragana characters “ni-ho” coincide with the two of the three hiragana characters “ni-ho-n”).

Likewise, a frequency-of-appearance ratio and a favorite ratio are presented in the form of a percent value that is normalized according to a certain standard. Points “16%” is calculated according to the following equation using numerical values of the above ratios. The same applies to the other candidate character strings.

(Points)=α×(hit ratio)+β×(frequency-of-appearance ratio)+γ×(favorite ratio)

In this equation, to attain normalization α+β+γ=1, the coefficients α, β, and γ are set at 0.1, 0.6, and 0.3, respectively. The three coefficients need not always be fixed; they may be varied adaptively by learning the situations of the three ratios.

Although TV receivers are known that are provided with an Internet browser function and can perform a free word search, no TV receiver is available in which such a search is performed in link with a broadcast. No TV receiver is available which enables character input in which keywords in a broadcast SI database are displayed as conversion result candidates. Furthermore, no TV receiver is available which enables direct hand-writing input of hiragana characters using the remote controller of a TV receiver.

The embodiment can provide a function for making a search to find up-to-date information early using the Internet. More specifically, the embodiment can provide the user with a convenient function that makes it possible to input hiragana characters as reading kana characters by hand writing through the electrostatic pad of the remote controller, call keywords that are considered suitable for the reading kana characters by inquiring of the broadcast SI database, present the keywords as conversion result candidates to the user in descending order of the points that is determined according to the hit ratio, the frequency-of-appearance ratio, and the favorite ratio, and make a search for up-to-date information using a resulting word. In summary, the invention provides the following:

(1) A search system which can use up-to-date information (e.g., sport events and persons) that will be involved in TV programs that have been broadcast recently in a search performed by the Internet browser of a TV receiver by selecting keywords stored in a digital broadcast SI database.

(2) A character input system which can extract, from an SI database, keywords that are considered suitable for part of hiragana characters (reading kana characters) that are character-input as a free word in a search of the above kind, present the keywords to the user as conversion result candidates, and cause the user to select one of the presented keywords.

(3) A conversion-into-keyword system which gives points to each suitable keyword in an SI database according to its hit ratio for part of hiragana characters that are input as reading kana characters, frequency of appearance in the SI database, and frequency of use in pieces of program information of programs that the user have viewed or made reservations for recording, and presents keywords to the user in descending order of the points as conversion result candidates.

(4) A character input system which displays a recognition result by performing character recognition based on pieces of coordinate information of an electrostatic pad of a remote controller when hiragana characters are input as reading kana characters.

The invention is not limited to the above embodiment, and various modifications are possible without departing from the spirit and scope of the invention.

Various inventions can be conceived by properly combining plural constituent elements disclosed in the embodiment. For example, several ones of the constituent elements of the embodiment may be omitted.

Although the embodiment according to the present invention has been described above, the present invention is not limited to the above-mentioned embodiments but can be variously modified. Constituent components disclosed in the aforementioned embodiment may be combined suitably to form various modifications. For example, some of all constituent components disclosed in the embodiment may be removed, replaced, or may be appropriately combined with other components.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A broadcast receiver comprising:
a storage configured to store pieces of program information of digital broadcast programs;
a user interface configured to receive input of characters relating to digital broadcast programs when a search relating to digital broadcast programs is to be performed using broadcast waves or the Internet;
a selecting module configured to select a keyword that is stored in the storage and considered to match the input characters; and
a search module configured to perform a program-related search using the selected keyword.

2. The broadcast receiver of claim 1 further comprising:
an output module configured to extract, from the storage, keywords that are considered to match a part of the characters that are input through the user interface as a character string, and to output the extracted keywords as conversion result candidates in a mode selectable by a user.

3. The broadcast receiver of claim 2,
wherein the output module is configured to extract the keywords from the storage by assigning points to each keyword according to its hit ratio for the part of the character string, frequency of appearance in the storage, and frequency of use in pieces of program information of programs that the user have viewed or made reservations for recording and to output the extracted keywords as conversion result candidates in descending order of the points.

4. The broadcast receiver of claim 2,
wherein the user interface is configured to receive input of the character string by performing character recognition based on pieces of coordinate information of an electrostatic pad of a remote controller and to supply a recognition result to the output module.

5. The broadcast receiver of claim 2 further comprising:
a display device configured to receive and display the conversion result candidates that are output from the output module.

6. The broadcast receiver of claim 1,
wherein the storage stores pieces of program information contained in pieces of Service Information.

7. A broadcast receiving method comprising:
storing pieces of program information of digital broadcast programs;
receiving input of characters relating to digital broadcast programs when a search relating to digital broadcast programs is to be performed using broadcast waves or the Internet;
selecting a keyword that is stored in the storage and considered to match the input characters; and
performing a program-related search using the selected keyword.
